(19) United States
(12) Patent Application Publication
(10) Pub. No.: US 2026/0253247 A1
(43) Pub. Date: Aug. 27, 2026

(54) DEVIATION AMOUNT DETECTING DEVICE, DEVIATION AMOUNT DETECTING METHOD, AND DRIVER MONITORING SYSTEM

(71) Applicant: Mitsubishi Electric Corporation, Tokyo (JP)

(72) Inventors: Kento TANAKA, Tokyo (JP); Shintaro WATANABE, Tokyo (JP); Atsushi MATSUMOTO, Tokyo (JP); Hirotaka SAKAMOTO, Tokyo (JP)

(73) Assignee: Mitsubishi Electric Corporation, Tokyo (JP)

(21) Appl. No.: 18/725,852

(22) PCT Filed: Jan. 11, 2022
(86) PCT No.: PCT/JP2022/000449

§ 371 Date: Jul. 1, 2024

(51) Int. Cl. G06T 7/73; B60W 40/08; G06V 10/44; G06V 10/75; G06V 20/59; G06V 40/10

(52) U.S. Cl. CPC G06T 7/73; B60W 40/08; G06V 10/44; G06V 10/751; G06V 20/597; G06V 40/10; B60W 2040/0818; B60W 2420/403; B60W 2540/229; G06T 2207/30196; G06T 2207/30244; G06T 2207/30268

(57) ABSTRACT

A deviation amount detecting device includes processing circuitry configured to; acquire an image of an inside of a vehicle and generate an edge image representing a contour of a structure in the image; acquire a reference image representing the contour of the structure; search for a reference pixel corresponding to each of imaging pixels; and output a pixel position of each of the imaging pixels and a pixel position of the reference pixel corresponding to each of the imaging pixels; and calculate a positional deviation amount, which is a deviation amount between the installation position of the imaging device and the correct installation position, from the pixel position of each of the imaging pixels and the pixel position of the reference pixel corresponding to each of the imaging pixels.

### TECHNICAL FIELD

The present disclosure relates to a deviation amount detecting device, a deviation amount detecting method, and a driver monitoring system.

### BACKGROUND ART

A camera that captures an image of an occupant is attached to a vehicle in which a driver monitoring system is mounted. The installation position of the camera may deviate from a correct installation position due to work errors or the like by a camera mounting worker. The correct installation position of the camera is, for example, an installation position indicated by a design value. By the installation position of the camera deviating from the correct installation position, an occupant appearing in an image captured by the camera becomes unclear, and as a result, monitoring accuracy of the driver monitoring system may deteriorate.

There is a deviation amount detecting device that detects a deviation amount between an installation position of an in-vehicle camera attached to a vehicle and a correct installation position of the in-vehicle camera (see Patent Literature 1). In the deviation amount detecting device, an electronic control unit extracts plane-symmetric feature points from a plane-symmetric object appearing in an image captured by the in-vehicle camera, and calculates a deviation amount from the plane-symmetric feature points.

### CITATION LIST

### Patent Literatures

Patent Literature 1: JP 2010-181209 A

### SUMMARY OF INVENTION

### Technical Problem

The calculation of the deviation amount by the deviation amount detecting device disclosed in Patent Literature 1 is based on the premise that the electronic control unit extracts plane-symmetric feature points. When the correct installation position of the in-vehicle camera is a position facing the plane-symmetric object and the in-vehicle camera is installed at the position facing the plane-symmetric object, the electronic control unit can extract the plane-symmetric feature points, but when the spacing between the installation position of the in-vehicle camera and the position facing the object is larger than an allowable range, the electronic control unit may not be able to extract the plane-symmetric feature points. Therefore, the deviation amount detecting device has a problem that the electronic control unit cannot calculate the deviation amount depending on the installation position of the in-vehicle camera.

The present disclosure has been made to solve the above problems, and an object thereof is to obtain a deviation amount detecting device and a deviation amount detecting method capable of detecting a deviation amount between an installation position of an imaging device and a correct installation position regardless of the installation position of the imaging device.

### Solution to Problem

A deviation amount detecting device according to the present disclosure includes an edge image generating unit to acquire an image of an inside of a vehicle captured by an imaging device, and generate an edge image representing a contour of a structure appearing in the image, a pixel searching unit to acquire a reference image representing a contour of the structure when an installation position of the imaging device is a correct installation position, search for a reference pixel corresponding to each of imaging pixels, which are a plurality of pixels indicating the contour represented by the edge image generated by the edge image generating unit, from among reference pixels, which are a plurality of pixels indicating the contour represented by the reference image, and output a pixel position of each of the imaging pixels and a pixel position of the reference pixel corresponding to each of the imaging pixels, and a deviation amount calculating unit to calculate a positional deviation amount, which is a deviation amount between the installation position of the imaging device and the correct installation position, from the pixel position of each of the imaging pixels output from the pixel searching unit and the pixel position of the reference pixel corresponding to each of the imaging pixels output from the pixel searching unit.

### Advantageous Effects of Invention

According to the present disclosure, it is possible to detect a deviation amount between an installation position of an imaging device and a correct installation position regardless of the installation position of the imaging device.

### BRIEF DESCRIPTION OF DRAWINGS

FIG. 1 is a configuration diagram illustrating a deviation amount detecting device 2 and a driver monitoring system 3 according to a first embodiment.

FIG. 2 is a hardware configuration diagram illustrating hardware of the deviation amount detecting device 2 according to the first embodiment.

FIG. 3 is a hardware configuration diagram illustrating hardware of the driver monitoring system 3 according to the first embodiment.

FIG. 4 is a hardware configuration diagram of a computer in a case where the deviation amount detecting device 2 is implemented by software, firmware, or the like.

FIG. 5A is an explanatory diagram illustrating a captured image when an installation position of the imaging device 1 is a correct installation position, and FIG. 5B is an explanatory diagram illustrating a captured image when the imaging device 1 is installed in a state of being angled in a vehicle height direction.

FIG. 6A is an explanatory diagram illustrating a captured image when the installation position of the imaging device 1 is the correct installation position, and FIG. 6B is an explanatory diagram illustrating a captured image when the imaging device 1 is installed in a state of being angled in a vehicle width direction.

FIG. 7A is an explanatory diagram illustrating a captured image when the installation position of the imaging device 1 is the correct installation position, and FIG. 7B is an explanatory diagram illustrating a captured image when the imaging device 1 is installed in a state of being rotated in an X-Y plane.

FIG. 8A is an explanatory diagram illustrating a captured image when the installation position of the imaging device 1 is the correct installation position, and FIG. 8B is an explanatory diagram illustrating a captured image when the imaging device 1 is installed in a state of being deviated in a front-rear direction.

FIG. 9 is a flowchart illustrating a deviation amount detecting method which is a processing procedure of the deviation amount detecting device 2.

FIG. 10A is an explanatory diagram illustrating an example of a captured image G_{P}, and FIG. 10B is an explanatory diagram illustrating an example of a captured image G_{P}″ after being deviated by optical axis deviation amounts Δ_{φX}, Δ_{φY}, and Δ_{φroll} by a sensing unit 31.

FIG. 11 is an explanatory diagram illustrating an example of an edge image G_{E}.

FIG. 12 is an explanatory diagram of M imaging pixels P_{E,1} to P_{E,M} indicating contours represented by an edge image G_{E}.

FIG. 13 is an explanatory diagram of N reference pixels P_{REF,1} to P_{REF,N} indicating a contour represented by a reference image G_{REF}.

FIG. 14 is a configuration diagram illustrating a deviation amount detecting device 2 and a driver monitoring system 3 according to a second embodiment.

FIG. 15 is a hardware configuration diagram illustrating hardware of the deviation amount detecting device 2 according to the second embodiment.

FIG. 16 is a hardware configuration diagram illustrating hardware of the driver monitoring system 3 according to the second embodiment.

FIG. 17 is a configuration diagram illustrating a deviation amount detecting device 2 and a driver monitoring system 3 according to a third embodiment.

FIG. 18 is a hardware configuration diagram illustrating hardware of the deviation amount detecting device 2 according to the third embodiment.

FIG. 19 is an explanatory diagram illustrating an example of a distance image G_{L}.

FIG. 20 is a configuration diagram illustrating a deviation amount detecting device 2 and a driver monitoring system 3 according to a fourth embodiment.

FIG. 21 is a hardware configuration diagram illustrating hardware of the deviation amount detecting device 2 according to the fourth embodiment.

### DESCRIPTION OF EMBODIMENTS

Hereinafter, in order to describe the present disclosure in more detail, modes for carrying out the present disclosure will be described with reference to the accompanying drawings.

### First Embodiment

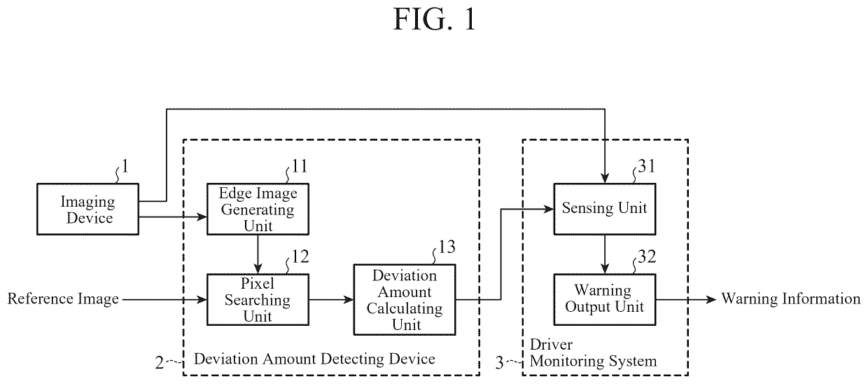

FIG. 1 is a configuration diagram illustrating a deviation amount detecting device 2 and a driver monitoring system 3 according to a first embodiment.

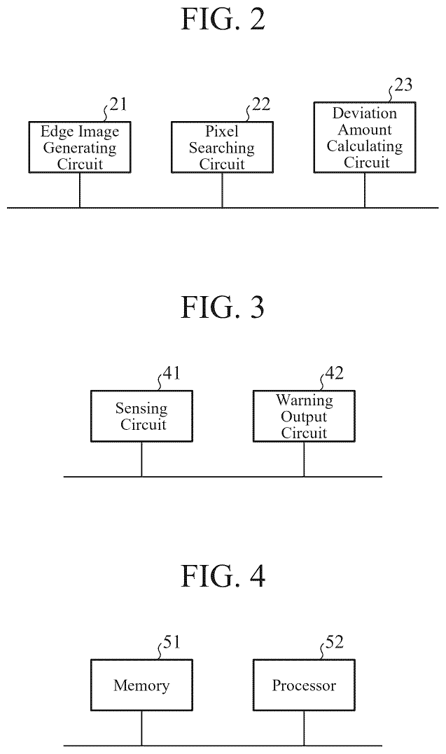

FIG. 2 is a hardware configuration diagram illustrating hardware of the deviation amount detecting device 2 according to the first embodiment.

FIG. 3 is a hardware configuration diagram illustrating hardware of the driver monitoring system 3 according to the first embodiment.

In FIG. 1, an imaging device 1 is installed, for example, on a center console, a steering wheel column, an A pillar, a rearview mirror, a dashboard, an instrument panel, or a ceiling of a vehicle.

The imaging device 1 is a camera that captures an image of a structure in a vehicle, a driver of the vehicle, or the like. The camera may be, for example, a visible light camera or an infrared camera.

The imaging device 1 outputs a captured image that is an image obtained by capturing a structure to the deviation amount detecting device 2, and outputs a captured image that is an image obtained by capturing a driver or the like of a vehicle to the driver monitoring system 3.

However, the captured image output from the imaging device 1 to the deviation amount detecting device 2 is an image used when the deviation amount detecting device 2 detects a deviation amount between an installation position of the imaging device 1 and a correct installation position. Thus, the captured image is, for example, an image captured by the imaging device 1 when the imaging device 1 is attached to the vehicle.

The captured image output from the imaging device 1 to the driver monitoring system 3 is an image used when the driver monitoring system 3 detects distracted driving or the like of the driver. Thus, the captured image is, for example, an image captured by the imaging device 1 when the driver is driving the vehicle.

The structure is, for example, a vehicle window frame, an assist grip, a headrest, a B-pillar, a door frame, a shoulder anchor, or a sun visor.

In the first embodiment, since the captured image of the imaging device 1 is used in the driver monitoring system 3, the imaging device 1 needs to be installed so that, for example, the face of the driver appears when the driver of the vehicle is seated on the driver's seat, and the structure appears when the driver is not seated on the driver's seat. In a case where the captured image of the imaging device 1 is not used by the driver monitoring system 3, the imaging device 1 does not need to be installed so that the face of the driver appears.

The deviation amount detecting device 2 detects a deviation amount between the installation position of the imaging device 1 and the correct installation position of the imaging device 1. The correct installation position of the imaging device 1 is, for example, an installation position indicated by a design value.

Further, the deviation amount detecting device 2 calculates, using a positional deviation amount, an optical axis deviation amount that is a deviation amount between an optical axis of the imaging device 1 and an optical axis of the imaging device 1 when an installation angle of the imaging device 1 is a correct installation angle. The correct optical axis of the imaging device 1 is, for example, an optical axis indicated by a design value.

The deviation amount detecting device 2 outputs the optical axis deviation amount to the driver monitoring system 3.

The driver monitoring system 3 acquires the captured image from the imaging device 1 and acquires the optical axis deviation amount from the deviation amount detecting device 2.

The driver monitoring system 3 monitors a state of an occupant of the vehicle on the basis of the optical axis deviation amount and the captured image.

The driver monitoring system 3 monitors the state of the occupant to detect, for example, distracted driving of the driver or dozing driving of the driver.

Upon detecting distracted driving, dozing driving, or the like of the driver, the driver monitoring system 3 outputs warning information indicating a warning to the driver to an electronic control unit or the like of the vehicle.

In the first embodiment, an example in which the driver monitoring system 3 detects distracted driving, dozing driving, or the like of the driver will be described. However, the driver monitoring system 3 is not limited to one that detects distracted driving or the like of the driver, and may be one that detects a state of an occupant of the vehicle other than the driver, for example. In this case, an occupant of the vehicle is imaged by the imaging device 1.

The deviation amount detecting device 2 includes an edge image generating unit 11, a pixel searching unit 12, and a deviation amount calculating unit 13.

The edge image generating unit 11 is implemented by, for example, an edge image generating circuit 21 illustrated in FIG. 2.

The edge image generating unit 11 acquires a captured image from the imaging device 1.

The edge image generating unit 11 generates an edge image representing a contour of the structure appearing in the captured image.

The edge image generating unit 11 outputs the edge image to the pixel searching unit 12.

The pixel searching unit 12 is implemented by, for example, a pixel searching circuit 22 illustrated in FIG. 2.

The pixel searching unit 12 acquires, from the outside, a reference image representing the contour of the structure when the installation position of the imaging device 1 is the correct installation position.

In the deviation amount detecting device 2 illustrated in FIG. 1, the pixel searching unit 12 acquires the reference image from the outside. However, this is merely an example, and the reference image may be recorded in the internal memory of the pixel searching unit 12.

The contour represented by the reference image includes a plurality of pixels (hereinafter referred to as “reference pixels”), and a contour represented by the edge image generated by the edge image generating unit 11 includes a plurality of pixels (hereinafter referred to as “imaging pixels”).

The pixel searching unit 12 searches for a reference pixel corresponding to each imaging pixel among the plurality of reference pixels.

The pixel searching unit 12 outputs a pixel position of each imaging pixel and a pixel position of the reference pixel corresponding to each imaging pixel to the deviation amount calculating unit 13.

The deviation amount calculating unit 13 is implemented by, for example, a deviation amount calculating circuit 23 illustrated in FIG. 2.

The deviation amount calculating unit 13 calculates a positional deviation amount, which is a deviation amount between the installation position of the imaging device 1 and the correct installation position, from the pixel position of each imaging pixel output from the pixel searching unit 12 and the pixel position of the reference pixel corresponding to each imaging pixel output from the pixel searching unit 12.

The deviation amount calculating unit 13 calculates, using the positional deviation amount, an optical axis deviation amount that is a deviation amount between the optical axis of the imaging device 1 and the optical axis of the imaging device 1 when the installation angle of the imaging device 1 is the correct installation angle.

The deviation amount calculating unit 13 outputs the optical axis deviation amount to the driver monitoring system 3.

The driver monitoring system 3 includes a sensing unit 31 and a warning output unit 32.

The sensing unit 31 is implemented by, for example, a sensing circuit 41 illustrated in FIG. 3.

The sensing unit 31 acquires the captured image from the imaging device 1 and acquires the optical axis deviation amount from the deviation amount calculating unit 13.

The sensing unit 31 monitors the state of the occupant of the vehicle on the basis of the optical axis deviation amount and the captured image.

The sensing unit 31 detects, for example, distracted driving of the driver or dozing driving of the driver by monitoring the state of the occupant.

The warning output unit 32 is implemented by, for example, a warning output circuit 42 illustrated in FIG. 3.

When the sensing unit 31 detects distracted driving, dozing driving, or the like of the driver, the warning output unit 32 outputs warning information indicating a warning to the driver to the electronic control unit or the like of the vehicle.

In FIG. 1, it is assumed that each of the edge image generating unit 11, the pixel searching unit 12, and the deviation amount calculating unit 13, which are components of the deviation amount detecting device 2, is implemented by dedicated hardware as illustrated in FIG. 2. That is, it is assumed that the deviation amount detecting device 2 is implemented by the edge image generating circuit 21, the pixel searching circuit 22, and the deviation amount calculating circuit 23.

Each of the edge image generating circuit 21, the pixel searching circuit 22, and the deviation amount calculating circuit 23 corresponds to, for example, a single circuit, a composite circuit, a programmed processor, a parallel-programmed processor, an application specific integrated circuit (ASIC), a field-programmable gate array (FPGA), or a combination thereof.

The components of the deviation amount detecting device 2 are not limited to those implemented by dedicated hardware, and the deviation amount detecting device 2 may be implemented by software, firmware, or a combination of software and firmware.

Software or firmware is stored in a memory of a computer as a program. The computer means hardware that executes a program, and corresponds to, for example, a central processing unit (CPU), a central processing device, a processing device, an arithmetic device, a microprocessor, a microcomputer, a processor, or a digital signal processor (DSP).

FIG. 4 is a hardware configuration diagram of a computer in a case where the deviation amount detecting device 2 is implemented by software, firmware, or the like.

In a case where the deviation amount detecting device 2 is implemented by software, firmware, or the like, a program for causing a computer to execute each processing procedure in the edge image generating unit 11, the pixel searching unit 12, and the deviation amount calculating unit 13 is stored in a memory 51. Then, a processor 52 of the computer executes the program stored in the memory 51.

In addition, FIG. 2 illustrates an example in which each of the components of the deviation amount detecting device 2 is implemented by dedicated hardware, and FIG. 4 illustrates an example in which the deviation amount detecting device 2 is implemented by software, firmware, or the like. However, this is merely an example, and some components in the deviation amount detecting device 2 may be implemented by dedicated hardware, and the remaining components may be implemented by software, firmware, or the like.

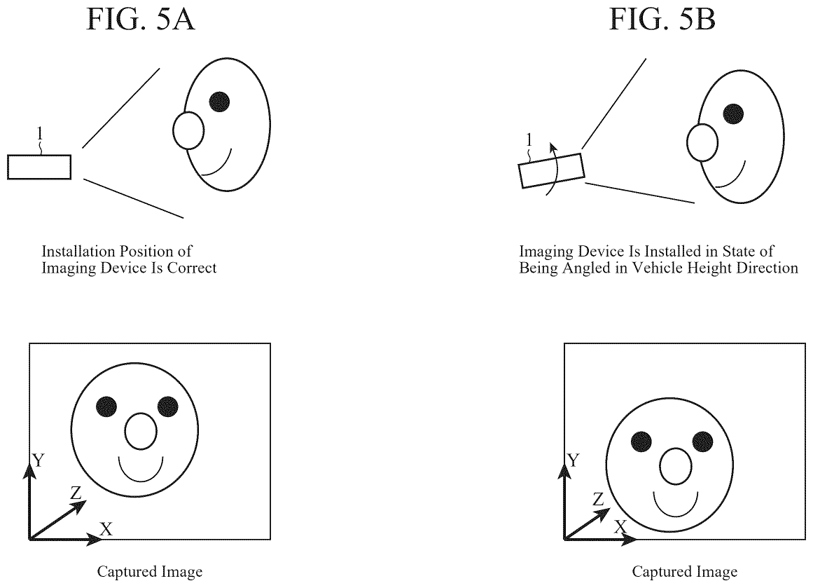

FIG. 5A is an explanatory diagram illustrating a captured image when the installation position of the imaging device 1 is a correct installation position, and FIG. 5B is an explanatory diagram illustrating a captured image when the imaging device 1 is installed in a state of being angled in a vehicle height direction.

In FIGS. 5A and 5B, the X axis is a direction parallel to a vehicle width direction, the Y axis is a direction parallel to the vehicle height direction, and the Z axis is a direction parallel to a front-rear direction of the vehicle.

In each of the captured images in FIGS. 5A and 5B, the face of the driver appears. When the installation position of the imaging device 1 is the correct installation position, the face of the driver appears at the correct position in the captured image. In the example of FIG. 5A, the correct position is approximately at the center of the captured image, and the face of the driver appears approximately at the center of the captured image.

When the imaging device 1 is installed in a state of being angled in the vehicle height direction, the face of the driver appears at a position deviated in the vehicle height direction from the correct position in the captured image as illustrated in FIG. 5B.

When the angle in the vehicle height direction is large, the face of the driver looks upward or downward, and as a result, it may be difficult for the driver monitoring system 3 to detect distracted driving or the like of the driver.

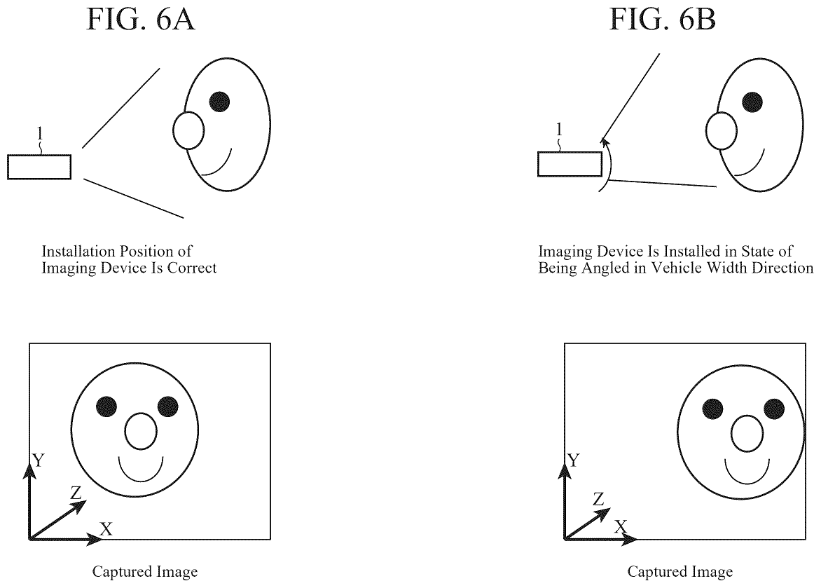

FIG. 6A is an explanatory diagram illustrating a captured image when the installation position of the imaging device 1 is the correct installation position, and FIG. 6B is an explanatory diagram illustrating a captured image when the imaging device 1 is installed in a state of being angled in the vehicle width direction.

In FIGS. 6A and 6B, the X axis, the Y axis, and the Z axis are similar to those in FIGS. 5A and 5B, respectively.

In each of the captured images in FIGS. 6A and 6B, the face of the driver appears. When the installation position of the imaging device 1 is the correct installation position, the face of the driver appears at the correct position in the captured image. In the example of FIG. 6A, the correct position is approximately at the center of the captured image, and the face of the driver appears approximately at the center of the captured image.

When the imaging device 1 is installed in a state of being angled in the vehicle width direction, the face of the driver appears at a position deviated in the vehicle width direction from the correct position in the captured image as illustrated in FIG. 6B.

When the angle in the vehicle width direction is large, the face of the driver appears to face leftward or rightward, and as a result, it may be difficult for the driver monitoring system 3 to detect distracted driving or the like of the driver.

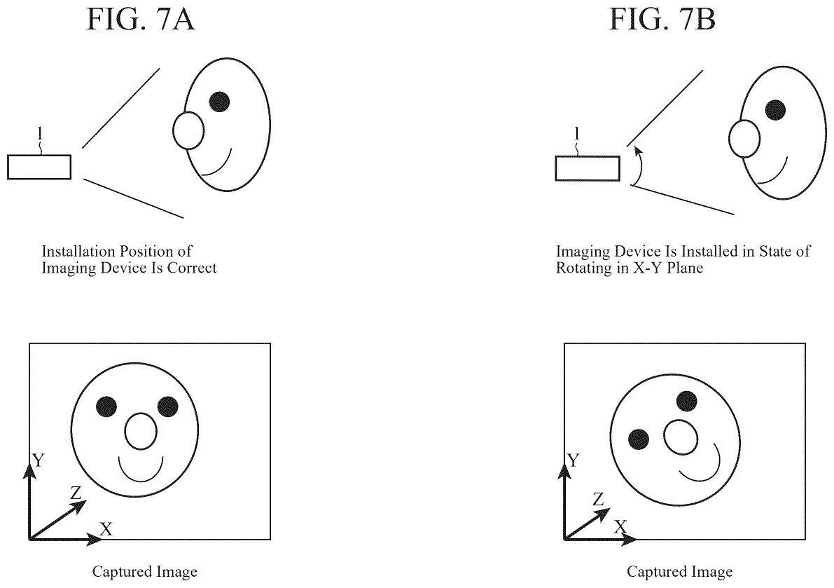

FIG. 7A is an explanatory diagram illustrating a captured image when the installation position of the imaging device 1 is the correct installation position, and FIG. 7B is an explanatory diagram illustrating a captured image when the imaging device 1 is installed in a state of being rotated in the X-Y plane.

In FIGS. 7A and 7B, the X axis, the Y axis, and the Z axis are similar to those in FIGS. 5A and 5B, respectively.

In each of the captured images in FIGS. 7A and 7B, the face of the driver appears. When the installation position of the imaging device 1 is the correct installation position, the face of the driver appears at the correct position in a state without rotation in the captured image. In the example of FIG. 7A, the correct position is approximately at the center of the captured image, and the face of the driver appears approximately at the center of the captured image in a state without rotation. The state without rotation is a state in which the face of the driver is appeared so that a line connecting the left eye and the right eye of the driver is substantially parallel to the X axis.

When the imaging device 1 is installed in a state of rotating in the X-Y plane, the face of the driver appears in a rotated state in the captured image as illustrated in FIG. 7B.

When the rotation angle is large, the face of the driver appears to face upward, downward, leftward, rightward, or a direction obtained by combining these directions, and as a result, it may be difficult for the driver monitoring system 3 to detect distracted driving or the like of the driver.

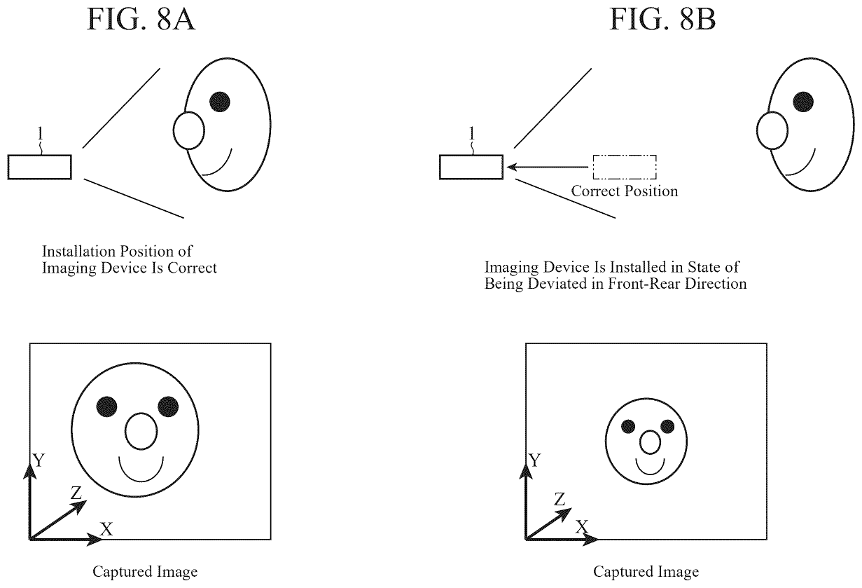

FIG. 8A is an explanatory diagram illustrating a captured image when the installation position of the imaging device 1 is the correct installation position, and FIG. 8B is an explanatory diagram illustrating a captured image when the imaging device 1 is installed in a state of being deviated in the front-rear direction.

In FIGS. 8A and 8B, the X axis, the Y axis, and the Z axis are similar to those in FIGS. 5A and 5B, respectively.

In each of the captured images in FIGS. 8A and 8B, the face of the driver appears. When the installation position of the imaging device 1 is the correct installation position, the face of the driver appears at the correct position in the captured image. In the example of FIG. 8A, the correct position is approximately at the center of the captured image, and the face of the driver appears approximately at the center of the captured image.

When the imaging device 1 is installed at a position deviated in the front-rear direction, the size of the face of the driver is enlarged or reduced from the original size in the captured image. In the example of FIG. 8B, the imaging device 1 is installed at a position farther from the driver than the correct installation position, and thus the size of the face of the driver is reduced than the original size.

When an enlargement ratio is too large, the face of the driver appears to face upward, downward, leftward, rightward, or a direction obtained by combining these directions. Further, when a reduction ratio is too large, it becomes difficult to distinguish the face of the driver. Thus, in a case where the imaging device 1 is installed at a position deviated in the front-rear direction, it may be difficult for the driver monitoring system 3 to detect distracted driving or the like of the driver.

Next, operations of the deviation amount detecting device 2 and the driver monitoring system 3 illustrated in FIG. 1 will be described.

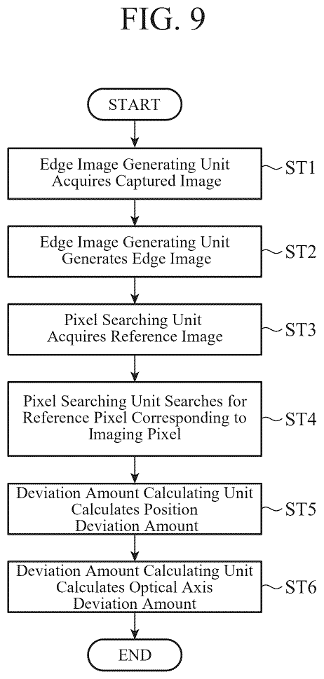

FIG. 9 is a flowchart illustrating a deviation amount detecting method which is a processing procedure of the deviation amount detecting device 2.

The imaging device 1 captures an image of a structure in the vehicle, and outputs a captured image G_{P} that is an image obtained by capturing the structure to the deviation amount detecting device 2.

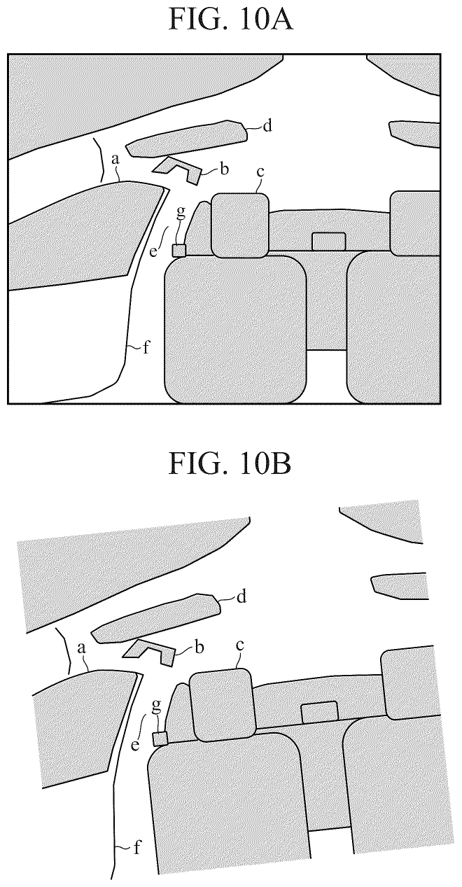

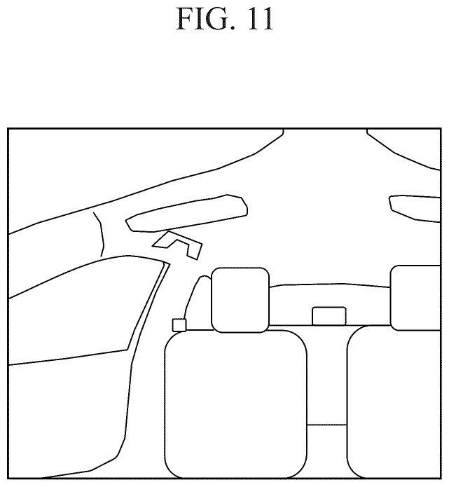

FIG. 10A is an explanatory diagram illustrating an example of the captured image G_{P}. The captured image G_{P} illustrated in FIG. 10A is, for example, a captured image of the imaging device 1 installed on the dashboard, and the captured image G_{P} includes, as structures, a window frame a, an assist grip b, a headrest c, a sun visor d, a B pillar e, a door frame f, a shoulder anchor g, and the like of the vehicle.

The captured image G_{P} output from the imaging device 1 to the deviation amount detecting device 2 is basically an image captured when the driver is not seated on the driver's seat. However, even when the driver is seated on the driver's seat, if the driver is seated so as not to block the structure, the captured image G_{P} may be an image captured when the driver is seated on the driver's seat.

The edge image generating unit 11 acquires the captured image G_{P} from the imaging device 1 (step ST1 in FIG. 9).

The edge image generating unit 11 generates an edge image G_{E} representing a contour of a structure appearing in the captured image G_{P} (step ST2 in FIG. 9).

As illustrated in FIG. 11, the contour of the structure is a line indicating a boundary between the structure and the background or the like expressed in three dimensions.

FIG. 11 is an explanatory diagram illustrating an example of the edge image G_{E}.

For example, the edge image generating unit 11 can obtain the edge image G_{E} by passing the captured image G_{P} through a Sobel filter or a Prewitt filter.

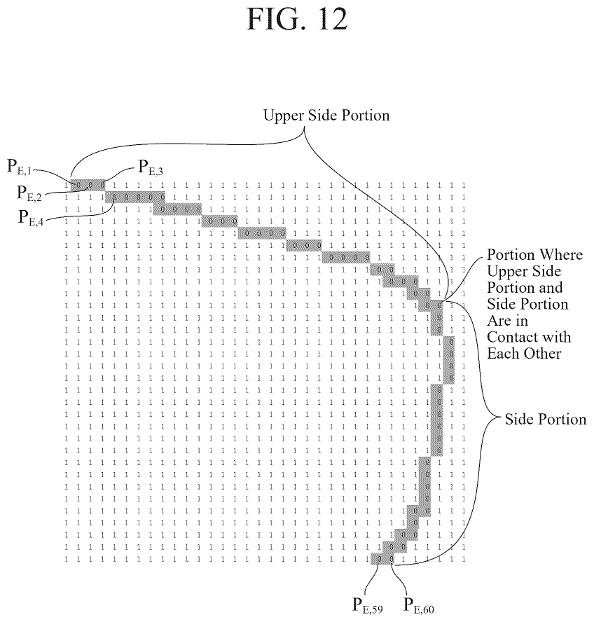

As illustrated in FIG. 12, the contour represented by the edge image G_{E} includes M imaging pixels P_{E,1} to P_{E,M}. M is an integer equal to or more than 2, and M=60 in an example of FIG. 12.

FIG. 12 is an explanatory diagram of the M imaging pixels P_{E,1} to P_{E,M} indicating the contour represented by the edge image G_{E}. In FIG. 12, for simplification of description, the edge image G_{E} is a two-dimensional image, and the M imaging pixels P_{E,1} to P_{E,M} indicating the contour represented by the two-dimensional edge image G_{E} are illustrated. Thus, the horizontal axis in FIG. 12 is the X axis, and the vertical axis is the Y axis, and does not indicate the Z axis.

In FIG. 12, pixels having a luminance value of 0 are the imaging pixels P_{E,1} to P_{E,M}, and pixels having a luminance value of 1 are pixels representing other than the contour.

For simplicity of description, the contour illustrated in FIG. 12 represents only a part of a window frame that is one structure among a plurality of structures appearing in the captured image G_{P}.

In the example of FIG. 12, the part of the window frame that is a structure includes an upper side portion of the window frame of the vehicle and a side portion of the window frame of the vehicle. The upper side portion of the window frame and the side portion of the window frame are in contact with each other. However, this is merely an example, and the part of the window frame that is a structure may include only the upper side portion of the window frame of the vehicle.

The edge image generating unit 11 outputs the edge image G_{E} to the pixel searching unit 12.

The pixel searching unit 12 acquires a reference image G_{REF} representing a contour of the structure from the outside (step ST3 in FIG. 9).

The reference image G_{REF} may be an image generated by passing a captured image when the installation position of the imaging device 1 is a correct installation position through a Sobel filter or the like, or may be an image generated by passing an image generated by computer aided design (CAD) through a Sobel filter or the like.

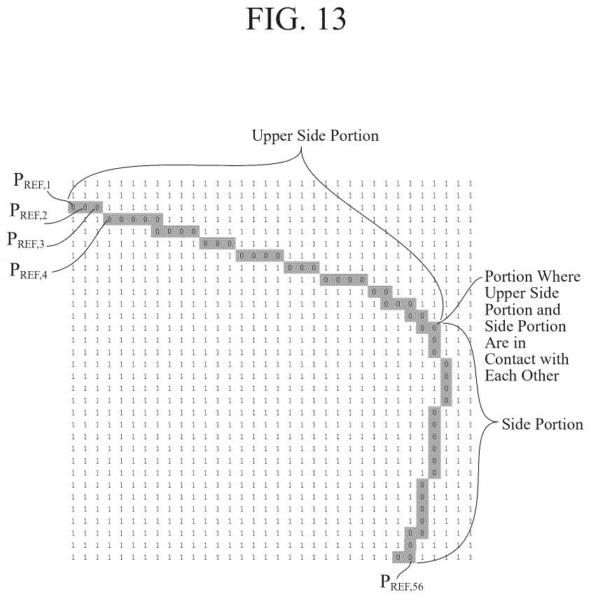

As illustrated in FIG. 13, the contour represented by the reference image G_{REF} includes N reference pixels P_{REF,1} to P_{REF,N}. N is an integer equal to or more than 2, and in an example of FIG. 13, N=56.

FIG. 13 is an explanatory diagram of N reference pixels P_{REF,1} to P_{REF,N} indicating the contour represented by the reference image G_{REF}. In FIG. 13, for simplification of description, the reference image G_{REF} is a two-dimensional image, and the N reference pixels P_{REF,1} to P_{REF,N} indicating the contour represented by the two-dimensional reference image G_{REF} are illustrated. Thus, the horizontal axis in FIG. 13 is the X axis, and the vertical axis is the Y axis, and does not indicate the Z axis.

In FIG. 13, pixels having a luminance value of 0 are the reference pixels P_{REF,1} to P_{REF,N}, and pixels having a luminance value of 1 are pixels representing other than the contour.

For simplification of description, the contour illustrated in FIG. 13 represents only a part of a window frame that is one structure among a plurality of structures.

In the example of FIG. 13, the part of the window frame that is a structure includes an upper side portion of the window frame of the vehicle and a side portion of the window frame of the vehicle. However, this is merely an example, and the part of the window frame that is a structure may include only the upper side portion of the window frame of the vehicle.

The pixel searching unit 12 acquires the edge image G_{E} from the edge image generating unit 11.

The pixel searching unit 12 searches for a reference pixel P_{REF,n} corresponding to the imaging pixel P_{E,m} (m=1, . . . , M) among the N reference pixels P_{REF,1} to P_{REF,N} (step ST4 in FIG. 9).

The processing of searching for the reference pixel P_{REF,n} corresponding to the imaging pixel P_{E,m} can be implemented by, for example, pattern matching processing between the contour represented by the reference image G_{REF} and the contour represented by the edge image G_{E}. Although the pattern matching processing itself is a known technique and thus detailed description thereof is omitted, the pattern matching processing can compare line shapes of two contours with each other and determine whether or not the two contours are the same line shapes. The same line shapes include similar line shapes. Further, in the pattern matching processing, when the two contours are the same line shapes, it is possible to search for a pixel corresponding to each of the plurality of pixels indicating one contour among the plurality of pixels representing the other contour.

The pixel searching unit 12 outputs a pixel position (xₘ, yₘ, zₘ) of the imaging pixel P_{E,m} (m=1, . . . , M) and a pixel position (xₙ, yₙ, zₙ) of the reference pixel P_{REF,n} corresponding to the imaging pixel P_{E,m} to the deviation amount calculating unit 13.

xₘ and xₙ are respective pixel positions in an X-axis direction in the edge image G_{E} and the reference image G_{REF}, yₘ and yₙ are respective pixel positions in a Y-axis direction in the edge image G_{E} and the reference image G_{REF}, and zₘ and zₙ are respective pixel positions in a Z-axis direction in the edge image G_{E} and the reference image G_{REF}.

Here, the pixel searching unit 12 outputs the pixel position (xₘ, yₘ, zₘ) of the imaging pixel P_{E,m} and the pixel position (xₙ, yₙ, zₙ) of the reference pixel P_{REF,n} corresponding to the imaging pixel P_{E,m} to the deviation amount calculating unit 13, with each of the edge image G_{E} and the reference image G_{REF} being a three-dimensional image. However, this is merely an example, and the pixel searching unit 12 may output a pixel position (xₘ, yₘ) of the imaging pixel P_{E,m} and a pixel position (xₙ, yₙ) of the reference pixel P_{REF,n} corresponding to the imaging pixel P_{E,m} to the deviation amount calculating unit 13, with each of the edge image G_{E} and the reference image G_{REF} being a two-dimensional image. Note that, even when each of the edge image G_{E} and the reference image G_{REF} is a three-dimensional image, the pixel searching unit 12 may output the pixel position (xₘ, yₘ, zₘ) of the imaging pixel P_{E,m} and the pixel position (xₙ, yₙ, zₙ) of the reference pixel P_{REF,n} corresponding to the imaging pixel P_{E,m} to the deviation amount calculating unit 13 without detecting zₘ and zₙ, with zₘ=zₙ=a known constant.

Each of FIGS. 12 and 13 illustrates a two-dimensional image, and the number of pixels in the X-axis direction and the number of pixels in the Y-axis direction of the two-dimensional image are 34 and 32, respectively. Thus, the two-dimensional image has 1088 (=34×32) pixels in total. Among the 1088 pixels included in the two-dimensional image, for example, when a pixel at an upper left end is set as a reference, the pixel position of the pixel at the upper left end is (x₁, y₁), a pixel position of a pixel adjacent to the right of the pixel at the upper left end is (x₂, y₁), and a pixel position of a pixel at a lower right end is (x₃₄, y₃₂).

Here, the pixel at the upper left end among the 1088 pixels included in the two-dimensional image is used as a reference. However, this is merely an example, and for example, a pixel at a lower left end may be used as a reference. In this case, the pixel position of the pixel at the lower left end is (x₁, y₁), the pixel position of the pixel on the right next to the pixel at the lower left end is (x₂, y₁), and the pixel position of the pixel at the upper right end is (x₃₄, y₃₂).

The deviation amount calculating unit 13 acquires the pixel position (xₘ, yₘ, zₘ) of the imaging pixel P_{E,m} (m=1, . . . , M) and the pixel position (xₙ, yₙ, zₙ) of the reference pixel P_{REF,n} corresponding to the imaging pixel P_{E,m} from the pixel searching unit 12.

The deviation amount calculating unit 13 calculates positional deviation amounts dxₙ₋ₘ, dyₙ₋ₘ, and dzₙ₋ₘ, which are deviation amounts between the installation position of the imaging device 1 and the correct installation position, as expressed in the following Expressions (1) to (3), from the pixel position (xₘ, yₘ, zₘ) of the imaging pixel P_{E,m} (m=1, . . . , M) and the pixel position (xₙ, yₙ, zₙ) of the reference pixel P_{REF,n} (step ST5 in FIG. 9).

$${dx}_{n - m} = {x}_{n} - {x}_{m} \qquad ( 1 )$$

$${dy}_{n - m} = {y}_{n} - {y}_{m} \qquad ( 2 )$$

$${dz}_{n - m} = {z}_{n} - {z}_{m} \qquad ( 3 )$$

In the examples of FIGS. 12 and 13, the contour represented by the edge image G_{E} has moved in parallel within the X-Y plane with respect to the contour represented by the reference image G_{REF}. That is, the pixel position (xₘ, yₘ, zₘ) of the imaging pixel P_{E,m} is deviated by one pixel in the X-axis direction and by two pixels in the Y-axis direction with respect to the pixel position (xₙ, yₙ, zₙ) of the reference pixel P_{REF,n}. Thus, when the pixel at the upper left end is used as a reference, dxₙ₋ₘ=−1 and dyₙ₋ₘ=2 are obtained.

In the examples of FIGS. 12 and 13, since each of the edge image G_{E} and the reference image G_{REF} is a two-dimensional image, dzₙ₋ₘ=0 is obtained. Even when each of the edge image G_{E} and the reference image G_{REF} is a three-dimensional image, if zₘ=zₙ=constant, dzₙ₋ₘ=0 is obtained.

The deviation amount calculating unit 13 calculates an optical axis deviation amount ΔΦ_{X} between an optical axis Φ_{X} in the X-axis direction in the imaging device 1 and an optical axis Φ_{XREF} in the X-axis direction in the imaging device 1 when there is no angular deviation in the X-axis direction by using the positional deviation amount dxₙ₋ₘ in the X-axis direction as expressed in the following Expression (4) (step ST6 in FIG. 9).

$$Δ {ϕ}_{X} = {tan}^{- 1} ( \frac{{dx}_{n - m}}{FL} ) \qquad ( 4 )$$

In Expression (4), FL is a focal length of the imaging device 1 and is known. The focal length is, for example, a distance between an image sensor (not illustrated) included in the imaging device 1 and a lens (not illustrated) included in the imaging device 1.

The deviation amount calculating unit 13 calculates an optical axis deviation amount ΔΦ_{Y} between an optical axis Φ_{Y} in the Y-axis direction in the imaging device 1 and an optical axis φ_{YREF} in the Y-axis direction in the imaging device 1 when there is no angular deviation in the Y-axis direction by using the positional deviation amount dyₙ₋ₘ in the Y-axis direction as expressed in the following Expression (5) (step ST6 in FIG. 9).

$$Δ {ϕ}_{Y} = {tan}^{- 1} ( \frac{{dy}_{n - m}}{\sqrt{{FL}^{2} + {dx}_{n - m}^{2}}} ) \qquad ( 5 )$$

Further, the deviation amount calculating unit 13 determines whether or not the contour represented by the reference image G_{REF} and the contour represented by the edge image G_{E} match by rotating one of the reference image G_{REF} or the edge image G_{E} in the X-Y plane.

When the contour represented by the reference image G_{REF} and the contour represented by the edge image G_{E} match by rotating one of the reference image G_{REF} or the edge image G_{E}, the deviation amount calculating unit 13 specifies the rotation amount of the reference image G_{REF} or the edge image G_{E} at the time of matching.

The deviation amount calculating unit 13 sets the specified rotation amount as an optical axis deviation amount ΔΦᵣₒₗₗ in the rotation direction in the X-Y plane.

When the contour represented by the reference image G_{REF} and the contour represented by the edge image G_{E} match in a state where neither the reference image G_{REF} nor the edge image G_{E} is rotated in the X-Y plane, the optical axis deviation amount Δφᵣₒₗₗ is 0.

The deviation amount calculating unit 13 outputs the optical axis deviation amounts ΔΦ_{X}, ΔΦ_{Y}, and Δφᵣₒₗₗ to the driver monitoring system 3.

The sensing unit 31 of the driver monitoring system 3 acquires a captured image G_{P}′ from the imaging device 1. The captured image G_{P}′ is an image captured when the driver is driving the vehicle.

Further, the sensing unit 31 acquires the optical axis deviation amounts ΔΦ_{X}, ΔΦ_{Y}, and ΔΦᵣₒₗₗ from the deviation amount calculating unit 13.

For example, the sensing unit 31 performs occupant sensing for identifying the position of the head of the driver appearing in the captured image G_{P}′.

When performing occupant sensing, the sensing unit 31 considers that there is a possibility that the installation position of the imaging device 1 is deviated from the correct installation position. For this reason, for example, when sensing the position of the head of the driver, the sensing unit 31 senses a position deviated by the optical axis deviation amounts ΔΦ_{X}, ΔΦ_{Y}, and Δ_{φroll} from the position of the head of the driver in the captured image G_{P}′.

Specifically, assuming that coordinates of the position of the driver's head in the captured image G_{P}′ are (x, y, z), coordinates (x′, y′, z′) of the position sensed by the sensing unit 31 are expressed by the following Expression (6).

$$( \begin{matrix}{x}^{′} \\ {y}^{′} \\ {z}^{′}\end{matrix} ) = ( \begin{matrix}cos ( - Δ {ϕ}_{X} ) & 0 & sin ( - Δ {ϕ}_{X} ) \\ 0 & 1 & 0 \\ - sin ( - Δ {ϕ}_{X} ) & 0 & cos ( - Δ {ϕ}_{X} )\end{matrix} ) ( \begin{matrix}1 & 0 & 0 \\ 0 & cos ( - Δ {ϕ}_{Y} ) & - sin ( - Δ {ϕ}_{Y} ) \\ 0 & sin ( - Δ {ϕ}_{Y} ) & cos ( - Δ {ϕ}_{Y} )\end{matrix} ) ( \begin{matrix}cos ( - Δ {ϕ}_{roll} ) & - sin ( - Δ {ϕ}_{roll} ) & 0 \\ sin ( - Δ {ϕ}_{roll} ) & cos ( - Δ {ϕ}_{roll} ) & 0 \\ 0 & 0 & 1\end{matrix} ) ( \begin{matrix}x \\ y \\ z\end{matrix} ) \qquad ( 6 )$$

FIG. 10B is an explanatory diagram illustrating an example of a captured image G_{P}″ after being deviated by the optical axis deviation amounts ΔΦ_{X}, ΔΦ_{Y}, and Δ_{φroll} by the sensing unit 31. FIG. 10B illustrates the captured image G_{P}″ in which the driver does not appear in order to simplify the drawing.

The sensing unit 31 monitors a state of an occupant of the vehicle on the basis of a pixel value of the coordinates (x′, y′, z′) in the captured image G_{P}′.

The sensing unit 31 detects, for example, distracted driving of the driver or dozing driving of the driver by monitoring the state of the occupant.

The processing itself of detecting distracted driving of the driver or dozing driving of the driver is a known technique, and thus a detailed description thereof will be omitted.

When the sensing unit 31 detects, for example, distracted driving of the driver or dozing driving of the driver, the warning output unit 32 outputs warning information indicating a warning to the driver to the electronic control unit or the like of the vehicle.

In the first embodiment described above, the deviation amount detecting device 2 is configured to include the edge image generating unit 11 to acquire an image of an inside of a vehicle captured by the imaging device 1, and generate an edge image representing a contour of a structure appearing in the image, the pixel searching unit 12 to acquire a reference image representing a contour of the structure when an installation position of the imaging device 1 is a correct installation position, search for a reference pixel corresponding to each of imaging pixels, which are a plurality of pixels indicating the contour represented by the edge image generated by the edge image generating unit 11, from among reference pixels, which are a plurality of pixels indicating the contour represented by the reference image, and output a pixel position of each of the imaging pixels and a pixel position of the reference pixel corresponding to each of the imaging pixels. Further, the deviation amount detecting device 2 includes a deviation amount calculating unit 13 to calculate a positional deviation amount, which is a deviation amount between the installation position of the imaging device 1 and the correct installation position, from the pixel position of each of the imaging pixels output from the pixel searching unit 12 and the pixel position of the reference pixel corresponding to each of the imaging pixels output from the pixel searching unit 12. Therefore, the deviation amount detecting device 2 can detect the deviation amount between the installation position of the imaging device 1 and the correct installation position regardless of the installation position of the imaging device 1.

In the deviation amount detecting device 2 illustrated in FIG. 1, the pixel searching unit 12 searches for the reference pixel P_{REF,n} corresponding to the imaging pixel P_{E,m} (m=1, . . . , M) among the N reference pixels P_{REF,1} to P_{REF,N} by pattern matching processing. When performing the pattern matching processing, the pixel searching unit 12 may roughly search for a position where the contour represented by the reference image G_{REF} and the contour represented by the edge image G_{E} correspond to each other, and then densely search for the reference pixel P_{REF,n} corresponding to the imaging pixel P_{E,m} (m=1, . . . , M) among the N reference pixels P_{REF,1} to P_{REF,N} on the basis of a position that has been found.

Some reference pixels among the N reference pixels P_{REF,1} to PREEN are used in the rough search for the position, and all of the N reference pixels P_{REF,1} to P_{REF,N} are used in the dense search for the reference pixel P_{REF,n} corresponding to the imaging pixel P_{E,m}. Thus, the time required for the pattern matching processing can be shortened.

In the driver monitoring system 3 illustrated in FIG. 1, the sensing unit 31 performs occupant sensing using the optical axis deviation amounts ΔΦ_{X}, ΔΦ_{Y}, and ΔΦᵣₒₗₗ and the captured image G_{P}′. However, this is merely an example, and the sensing unit 31 may perform occupant sensing using the optical axis deviation amounts ΔΦ_{X}, ΔΦ_{Y}, and ΔΦᵣₒₗₗ, Δ_{scale}, and the captured image G_{P}′ as expressed in the following Expression (7).

$$( \begin{matrix}{x}^{′} \\ {y}^{′} \\ {z}^{′}\end{matrix} ) = ( \begin{matrix}cos ( - Δ {ϕ}_{X} ) & 0 & sin ( - Δ {ϕ}_{X} ) \\ 0 & 1 & 0 \\ - sin ( - Δ {ϕ}_{X} ) & 0 & cos ( - Δ {ϕ}_{X} )\end{matrix} ) ( \begin{matrix}1 & 0 & 0 \\ 0 & cos ( - Δ {ϕ}_{Y} ) & - sin ( - Δ {ϕ}_{Y} ) \\ 0 & sin ( - Δ {ϕ}_{Y} ) & cos ( - Δ {ϕ}_{Y} )\end{matrix} ) ( \begin{matrix}cos ( - Δ {ϕ}_{roll} ) & - sin ( - Δ {ϕ}_{roll} ) & 0 \\ sin ( - Δ {ϕ}_{roll} ) & cos ( - Δ {ϕ}_{roll} ) & 0 \\ 0 & 0 & 1\end{matrix} ) ( \begin{matrix}x \\ y \\ z\end{matrix} ) {Δ}_{scale} \qquad ( 7 )$$

Δ_{scale} can be calculated by the pixel searching unit 12 or the deviation amount detecting device 2 by the following method.

The pixel searching unit 12 or the deviation amount detecting device 2 focuses on, for example, the upper side portion of the window frame represented in each of the edge image G_{E} and the reference image G_{REF}.

Even when shapes of the upper side portion of the window frame represented by the edge image G_{E} and the upper side portion of the window frame represented by the reference image G_{REF} do not match each other, the pixel searching unit 12 or the deviation amount detecting device 2 determines whether or not the shapes of both the upper side portions match each other by enlarging or reducing one of the upper side portions.

In a case where the shapes of both the upper side portions match each other by enlarging or reducing one of the upper side portions, the pixel searching unit 12 or the deviation amount detecting device 2 outputs an enlargement ratio of one of the upper side portions or a reduction ratio of one of the upper side portions to the sensing unit 31 as Δ_{scale}.

By correcting the captured image G_{P}′ using the optical axis deviation amounts ΔΦ_{X}, ΔΦ_{Y}, and ΔΦᵣₒₗₗ and Δ_{scale}, the sensing unit 31 can compensate for a field angle deviation that may occur at the time of manufacturing the imaging device 1. In the imaging device 1 including an image sensor and a lens, a distance between the image sensor after attachment and the lens after attachment is different from an original correct distance, which causes a field angle deviation. The size of a structure appearing in the image changes due to the field angle deviation.

Here, the pixel searching unit 12 and the like focus on the upper side portion of the window frame represented by each of the edge image G_{E} and the reference image G_{REF}. However, this is merely an example, and the pixel searching unit 12 and the like may, for example, focus on side portions of the window frames represented by the edge image G_{E} and the reference image G_{REF} and determine whether or not shapes of both the side portions match each other.

In a case where the shapes of both the side portions match each other by enlarging or reducing one of the side portions, the pixel searching unit 12 or the like outputs an enlargement ratio of one of the side portions or a reduction ratio of one of the side portions to the sensing unit 31 as Δ_{scale}.

### Second Embodiment

In a second embodiment, a deviation amount detecting device 2 including an image correcting unit 14 will be described.

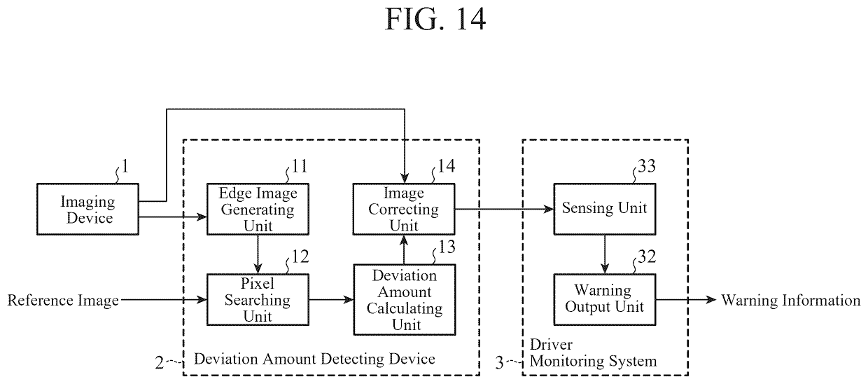

FIG. 14 is a configuration diagram illustrating the deviation amount detecting device 2 and a driver monitoring system 3 according to the second embodiment. In FIG. 14, the same reference numerals as those in FIG. 1 denote the same or corresponding parts, and thus description thereof is omitted.

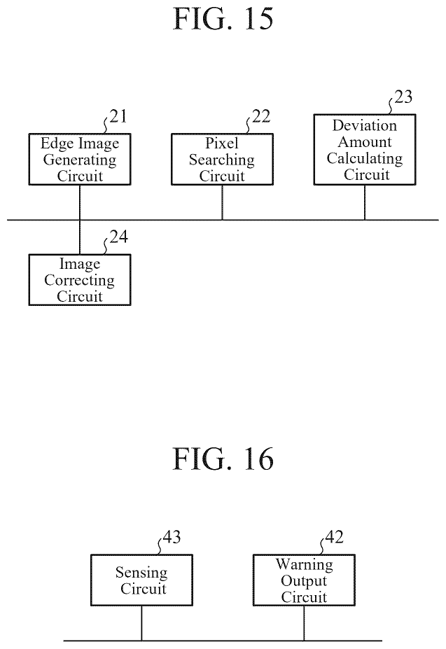

FIG. 15 is a hardware configuration diagram illustrating hardware of the deviation amount detecting device 2 according to the second embodiment. In FIG. 15, the same reference numerals as those in FIG. 2 denote the same or corresponding parts, and thus description thereof is omitted.

FIG. 16 is a hardware configuration diagram illustrating hardware of the driver monitoring system 3 according to the second embodiment. In FIG. 16, the same reference numerals as those in FIG. 3 denote the same or corresponding parts, and thus description thereof is omitted.

The deviation amount detecting device 2 illustrated in FIG. 14 includes the edge image generating unit 11, the pixel searching unit 12, the deviation amount calculating unit 13, and an image correcting unit 14.

The image correcting unit 14 is implemented by, for example, an image correcting circuit 24 illustrated in FIG. 15.

The image correcting unit 14 acquires the captured image G_{P}′ from the imaging device 1, and acquires the optical axis deviation amounts ΔΦ_{X}, ΔΦ_{Y}, and ΔΦᵣₒₗₗ from the deviation amount calculating unit 13.

The image correcting unit 14 corrects the captured image G_{P}′ using the optical axis deviation amounts ΔΦ_{X}, ΔΦ_{Y}, and ΔΦᵣₒₗₗ.

The image correcting unit 14 outputs the corrected captured image G_{P}″ to a sensing unit 33 of the driver monitoring system 3.

The driver monitoring system 3 illustrated in FIG. 14 includes the sensing unit 33 and the warning output unit 32.

The sensing unit 33 is implemented by, for example, a sensing circuit 43 illustrated in FIG. 3.

The sensing unit 33 acquires the corrected captured image G_{P}″ from the image correcting unit 14.

The sensing unit 33 detects distracted driving, dozing driving, or the like of the driver on the basis of the corrected captured image G_{P}″.

In FIG. 14, it is assumed that each of the edge image generating unit 11, the pixel searching unit 12, the deviation amount calculating unit 13, and the image correcting unit 14, which are components of the deviation amount detecting device 2, is implemented by dedicated hardware as illustrated in FIG. 15. That is, it is assumed that the deviation amount detecting device 2 is implemented by the edge image generating circuit 21, the pixel searching circuit 22, the deviation amount calculating circuit 23, and the image correcting circuit 24.

Each of the edge image generating circuit 21, the pixel searching circuit 22, the deviation amount calculating circuit 23, and the image correcting circuit 24 corresponds to, for example, a single circuit, a composite circuit, a programmed processor, a parallel-programmed processor, ASIC, FPGA, or a combination thereof.

The components of the deviation amount detecting device 2 are not limited to those implemented by dedicated hardware, and the deviation amount detecting device 2 may be implemented by software, firmware, or a combination of software and firmware.

In a case where the deviation amount detecting device 2 is implemented by software, firmware, or the like, a program for causing a computer to execute each processing procedure in the edge image generating unit 11, the pixel searching unit 12, the deviation amount calculating unit 13, and the image correcting unit 14 is stored in the memory 51 illustrated in FIG. 4. Then, the processor 52 illustrated in FIG. 4 executes the program stored in the memory 51.

Further, FIG. 15 illustrates an example in which each of the components of the deviation amount detecting device 2 is implemented by dedicated hardware, and FIG. 4 illustrates an example in which the deviation amount detecting device 2 is implemented by software, firmware, or the like. However, this is merely an example, and some components in the deviation amount detecting device 2 may be implemented by dedicated hardware, and the remaining components may be implemented by software, firmware, or the like.

Next, operations of the deviation amount detecting device 2 and the driver monitoring system 3 illustrated in FIG. 14 will be described.

The operations other than the image correcting unit 14 and the sensing unit 33 are similar to those of the deviation amount detecting device 2 and the driver monitoring system 3 illustrated in FIG. 1, and thus only the operations of the image correcting unit 14 and the sensing unit 33 will be described here.

The image correcting unit 14 of the deviation amount detecting device 2 acquires the captured image G_{P}′ from the imaging device 1, and acquires the optical axis deviation amounts ΔΦ_{X}, ΔΦ_{Y}, and ΔΦᵣₒₗₗ from the deviation amount calculating unit 13.

The captured image G_{P}′ acquired by the image correcting unit 14 from the imaging device 1 is an image captured when the driver is driving the vehicle.

Similarly to the sensing unit 31 illustrated in FIG. 1, the image correcting unit 14 corrects the captured image G_{P}′ using the optical axis deviation amounts ΔΦ_{X}, ΔΦ_{Y}, and ΔΦᵣₒₗₗ.

That is, the image correcting unit 14 corrects the captured image G_{P}′ by converting the pixel position (x, y, z) of the imaging pixel p into the pixel position (x′, y′, z′) as expressed in the above Expression (6).

The image correcting unit 14 outputs the corrected captured image G_{P}″ to the sensing unit 33.

The sensing unit 33 acquires the corrected captured image G_{P}″ from the image correcting unit 14.

Similarly to the sensing unit 31 illustrated in FIG. 1, the sensing unit 33 detects distracted driving, dozing driving, or the like of the driver on the basis of the corrected captured image G_{P}″.

As described above, the deviation amount detecting device 2 illustrated in FIG. 14 can detect the deviation amount between the installation position of the imaging device 1 and the correct installation position regardless of the installation position of the imaging device 1, similarly to the deviation amount detecting device 2 illustrated in FIG. 1.

### Third Embodiment

In a third embodiment, a deviation amount detecting device 2 including a distance image generating unit 15 will be described.

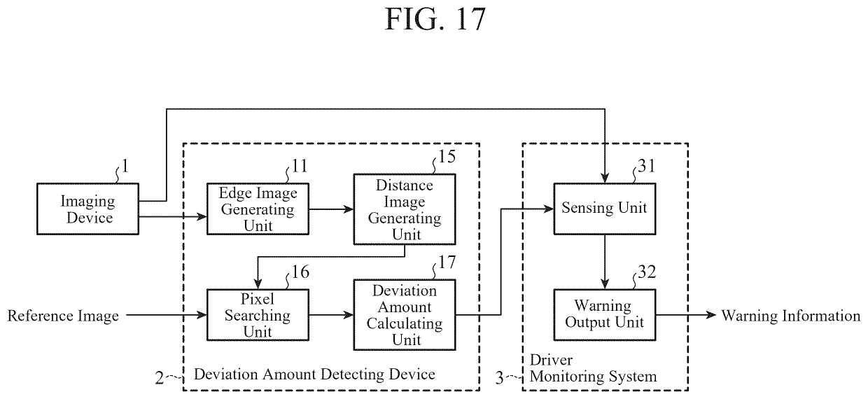

FIG. 17 is a configuration diagram illustrating the deviation amount detecting device 2 and the driver monitoring system 3 according to the third embodiment. In FIG. 17, the same reference numerals as those in FIG. 1 denote the same or corresponding parts, and thus description thereof is omitted.

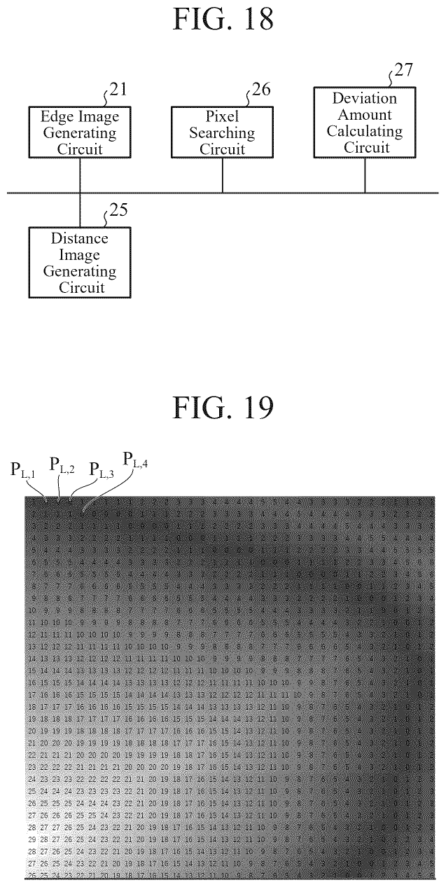

FIG. 18 is a hardware configuration diagram illustrating hardware of the deviation amount detecting device 2 according to the third embodiment. In FIG. 18, the same reference numerals as those in FIG. 2 denote the same or corresponding parts, and thus description thereof is omitted.

The deviation amount detecting device 2 illustrated in FIG. 17 includes the edge image generating unit 11, a distance image generating unit 15, a pixel searching unit 16, and a deviation amount calculating unit 17.

The distance image generating unit 15 is implemented by a distance image generating circuit 25 illustrated in FIG. 18, for example.

The distance image generating unit 15 generates, from the edge image G_{E} generated by the edge image generating unit 11, a distance image G_{L} in which a pixel at a position farther from the contour represented by the edge image G_{E} has a larger luminance value. The distance image G_{L} includes H distance pixels P_{L,1} to P_{L,H}. H is an integer equal to or more than 2.

The distance image generating unit 15 outputs the distance image G_{L} to the pixel searching unit 16.

The pixel searching unit 16 is implemented by, for example, a pixel searching circuit 26 illustrated in FIG. 18.

The pixel searching unit 16 acquires, from the outside, a reference image G_{REF} representing the contour of the structure when the installation position of the imaging device 1 is the correct installation position.

In the deviation amount detecting device 2 illustrated in FIG. 17, the pixel searching unit 16 acquires the reference image G_{REF} from the outside. However, this is merely an example, and the reference image G_{REF} may be recorded in the internal memory of the pixel searching unit 16.

The pixel searching unit 16 acquires the distance image G_{L} from the distance image generating unit 15.

The pixel searching unit 16 searches for a reference pixel P_{REF,n} corresponding to a distance pixel P_{L,h} (h=1, . . . , H) indicating a contour represented by the distance image G_{L} among the N reference pixels P_{REF,1} to P_{REF,N}.

The pixel searching unit 16 outputs a pixel position of the distance pixel P_{L,h} (h=1, . . . , H) and a pixel position of the reference pixel P_{REF,n} corresponding to the distance pixel P_{L,h} to the deviation amount calculating unit 17.

The deviation amount calculating unit 17 is implemented by, for example, a deviation amount calculating circuit 27 illustrated in FIG. 18.

The deviation amount calculating unit 17 acquires the pixel position of the distance pixel P_{L,h} (h=1, . . . , H) and the pixel position of the reference pixel P_{REF,n} corresponding to the distance pixel P_{L,h} from the pixel searching unit 16.

The deviation amount calculating unit 17 calculates positional deviation amounts dxₙ₋ₘ, dyₙ₋ₘ, and dzₙ₋ₘ, which are deviation amounts between the installation position of the imaging device 1 and the correct installation position, from the pixel position of the distance pixel P_{L,h} (h=1, . . . , H) and the pixel position of the reference pixel P_{REF,n} corresponding to the distance pixel P_{L,h}.

Similarly to the deviation amount calculating unit 13 illustrated in FIG. 1, the deviation amount calculating unit 17 calculates optical axis deviation amounts ΔΦ_{X}, ΔΦ_{Y}, and ΔΦᵣₒₗₗ using the positional deviation amounts dxₙ₋ₘ, dyₙ₋ₘ, and dzₙ₋ₘ.

The deviation amount calculating unit 17 outputs the optical axis deviation amounts ΔΦ_{X}, ΔΦ_{Y}, and ΔΦᵣₒₗₗ to the driver monitoring system 3.

In the deviation amount detecting device 2 illustrated in FIG. 17, the distance image generating unit 15, the pixel searching unit 16, and the deviation amount calculating unit 17 are applied to the deviation amount detecting device 2 illustrated in FIG. 1. However, this is merely an example, and the distance image generating unit 15, the pixel searching unit 16, and the deviation amount calculating unit 17 may be applied to the deviation amount detecting device 2 illustrated in FIG. 14.

In FIG. 17, it is assumed that each of the edge image generating unit 11, the distance image generating unit 15, the pixel searching unit 16, and the deviation amount calculating unit 17, which are components of the deviation amount detecting device 2, is implemented by dedicated hardware as illustrated in FIG. 18. That is, it is assumed that the deviation amount detecting device 2 is implemented by the edge image generating circuit 21, the distance image generating circuit 25, the pixel searching circuit 26, and the deviation amount calculating circuit 27.

Each of the edge image generating circuit 21, the distance image generating circuit 25, the pixel searching circuit 26, and the deviation amount calculating circuit 27 corresponds to, for example, a single circuit, a composite circuit, a programmed processor, a parallel-programmed processor, ASIC, FPGA, or a combination thereof.

The components of the deviation amount detecting device 2 are not limited to those implemented by dedicated hardware, and the deviation amount detecting device 2 may be implemented by software, firmware, or a combination of software and firmware.

In a case where the deviation amount detecting device 2 is implemented by software, firmware, or the like, a program for causing a computer to execute each processing procedure in the edge image generating unit 11, the distance image generating unit 15, the pixel searching unit 16, and the deviation amount calculating unit 17 is stored in the memory 51 illustrated in FIG. 4. Then, the processor 52 illustrated in FIG. 4 executes the program stored in the memory 51.

Further, FIG. 18 illustrates an example in which each of the components of the deviation amount detecting device 2 is implemented by dedicated hardware, and FIG. 4 illustrates an example in which the deviation amount detecting device 2 is implemented by software, firmware, or the like. However, this is merely an example, and some components in the deviation amount detecting device 2 may be implemented by dedicated hardware, and the remaining components may be implemented by software, firmware, or the like.

Next, operations of the deviation amount detecting device 2 and the driver monitoring system 3 illustrated in FIG. 17 will be described.

The edge image generating unit 11 acquires the captured image G_{P} from the imaging device 1, and generates the edge image G_{E} representing the contour of the structure appearing in the captured image G_{P}.

The edge image generating unit 11 outputs the edge image G_{E} to the distance image generating unit 15.

The distance image generating unit 15 acquires the edge image G_{E} from the edge image generating unit 11.

As illustrated in FIG. 19, the distance image generating unit 15 generates, from the edge image G_{E}, the distance image G_{L} in which a pixel at a position farther from the contour represented by the edge image G_{E} has a larger luminance value. The distance image G_{L} includes H distance pixels P_{L,1} to P_{L,H}.

FIG. 19 is an explanatory diagram illustrating an example of the distance image G_{L}. FIG. 19 illustrates a two-dimensional distance image G_{L} for simplification of description. Thus, the horizontal axis in FIG. 19 is the X axis, the vertical axis is the Y axis, and the Z axis is not illustrated.

In FIG. 19, a pixel having a luminance value of 0 is a pixel representing a contour of a structure. A pixel having a luminance value of 1 is a pixel adjacent to a pixel indicating the contour of the structure. A pixel having a luminance value of 2 is a pixel that is two pixels away from a pixel indicating the contour in the X-axis direction, a pixel that is two pixels away from a pixel indicating the contour in the Y-axis direction, or a pixel that is one pixel away from the pixel indicating the contour in the X-axis direction and one pixel away from the pixel indicating the contour in the Y-axis direction.

The distance image generating unit 15 outputs the distance image G_{L} to the pixel searching unit 16.

The pixel searching unit 16 acquires the reference image G_{REF} from the outside, and acquires the distance image G_{L} from the distance image generating unit 15.

The pixel searching unit 16 searches for a reference pixel P_{REF,n} corresponding to a distance pixel P_{L,h} (h=1, . . . , H) indicating a contour represented by the distance image G_{L} among the N reference pixels P_{REF,1} to P_{REF,N}.

The pixel searching unit 16 outputs the pixel position (xₘ, yₘ, zₘ) of the distance pixel P_{L,h} (h=1, . . . , H) and the pixel position (xₙ, yₙ, zₙ) of the reference pixel P_{REF,n} corresponding to the distance pixel P_{L,h} to the deviation amount calculating unit 17.

The processing of searching for the reference pixel P_{REF,n} corresponding to the distance pixel P_{L,h} can be implemented by, for example, pattern matching processing between the contour of the structure indicated by the reference image G_{REF} and the contour of the structure indicated by the distance image G_{L}. The distance pixel P_{L,h} included in the distance image G_{L} has a larger luminance value at a position farther from the contour. Thus, in pattern matching processing between the contour of the structure indicated by the reference image G_{REF} and the contour of the structure indicated by the distance image G_{L}, when searching for the contour of the structure indicated by the distance image G_{L} corresponding to the contour of the structure indicated by the reference image G_{REF}, it may be possible to narrow down pixels to be searched for the contour among a plurality of pixels included in the distance image G_{L}. For example, when the line shape of the contour represented by the reference image G_{REF} and the line shape of the contour represented by the distance image G_{L} do not completely match, when searching for a contour having similar line shapes as the corresponding contour, it is possible to narrow down pixels to be searched for the contour among a plurality of pixels included in the distance image G_{L}. Specifically, among the plurality of pixels included in the distance image G_{L}, for example, only pixels having luminance values equal to or less than 2 can be narrowed down to pixels to be searched for a contour.

Therefore, the pattern matching processing between the contour of the structure indicated by the reference image G_{REF} and the contour of the structure indicated by the distance image G_{L} can shorten the time required for the processing as compared with the pattern matching processing between the contour of the structure indicated by the reference image G_{REF} and the contour of the structure indicated by the edge image G_{E}.

The deviation amount calculating unit 17 acquires the pixel position (xₘ, yₘ, zₘ) of the distance pixel P_{L,h} (h=1, . . . , H) and the pixel position (xₙ, yₙ, zₙ) of the reference pixel P_{REF,n} corresponding to the distance pixel P_{L,h} from the pixel searching unit 16.

The deviation amount calculating unit 17 calculates positional deviation amounts dxₙ₋ₘ, dyₙ₋ₘ, and dzₙ₋ₘ, which are deviation amounts between the installation position of the imaging device 1 and the correct installation position, as expressed in the above Expressions (1) to (3), from the pixel position (xₘ, yₘ, zₘ) of the distance pixel P_{L,h} (h=1, . . . , H) and the pixel position (xₙ, yₙ, zₙ) of the reference pixel P_{REF,n} corresponding to the distance pixel P_{L,h}.

Similarly to the deviation amount calculating unit 13 illustrated in FIG. 1, the deviation amount calculating unit 17 calculates optical axis deviation amounts ΔΦ_{X}, ΔΦ_{Y}, and ΔΦᵣₒₗₗ using the positional deviation amounts dxₙ₋ₘ, dyₙ₋ₘ, and dzₙ₋ₘ.

The deviation amount calculating unit 17 outputs the optical axis deviation amounts ΔΦ_{X}, ΔΦ_{Y}, and ΔΦᵣₒₗₗ to the driver monitoring system 3.

As described above, the deviation amount detecting device 2 illustrated in FIG. 17 can detect the deviation amount between the installation position of the imaging device 1 and the correct installation position regardless of the installation position of the imaging device 1, similarly to the deviation amount detecting device 2 illustrated in FIG. 1.

### Fourth Embodiment

In a fourth embodiment, a deviation amount detecting device 2 including a deviation amount calculating unit 18 that calculates a matching degree C. between a line shape of a contour represented by a reference image G_{REF} and a line shape of a contour represented by an edge image G_{E} will be described.

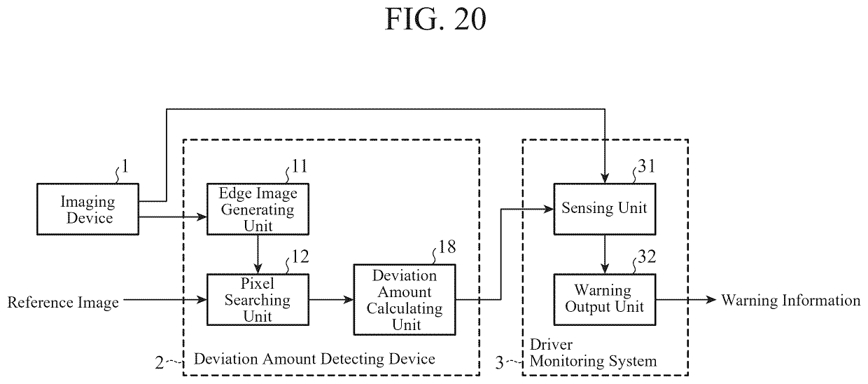

FIG. 20 is a configuration diagram illustrating the deviation amount detecting device 2 and the driver monitoring system 3 according to the fourth embodiment. In FIG. 20, the same reference numerals as those in FIG. 1 denote the same or corresponding parts, and thus description thereof is omitted.

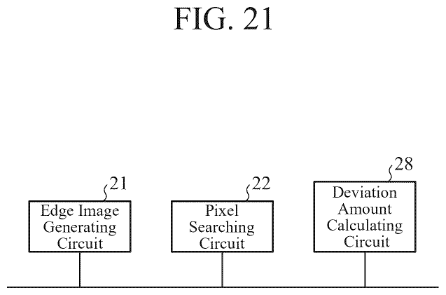

FIG. 21 is a hardware configuration diagram illustrating hardware of the deviation amount detecting device 2 according to the fourth embodiment. In FIG. 21, the same reference numerals as those in FIG. 2 denote the same or corresponding parts, and thus description thereof is omitted.

The deviation amount detecting device 2 includes the edge image generating unit 11, the pixel searching unit 12, and the deviation amount calculating unit 18.

The deviation amount calculating unit 18 is implemented by, for example, a deviation amount calculating circuit 28 illustrated in FIG. 21.

The deviation amount calculating unit 18 acquires each of the reference image G_{REF} and the edge image G_{E} from the pixel searching unit 12.

The deviation amount calculating unit 18 calculates a matching degree C. between the line shape of the contour represented by the reference image G_{REF} and the line shape of the contour represented by the edge image G_{E}.

When the matching degree C. is equal to or greater than a threshold Th, the deviation amount calculating unit 18 calculates positional deviation amounts dxₙ₋ₘ, dyₙ₋ₘ, and dzₙ₋ₘ from the pixel position (xₘ, yₘ, zₘ) of the imaging pixel P_{E,m} (m=1, . . . , M) output from the pixel searching unit 12 and the pixel position (xₙ, yₙ, zₙ) of the reference pixel P_{REF,n} corresponding to the imaging pixel P_{E,m} output from the pixel searching unit 12, similarly to the deviation amount calculating unit 13 illustrated in FIG. 1. Further, similarly to the deviation amount calculating unit 13 illustrated in FIG. 1, the deviation amount calculating unit 18 calculates optical axis deviation amounts ΔΦ_{X}, ΔΦ_{Y}, and ΔΦᵣₒₗₗ using the positional deviation amounts dxₙ₋ₘ, dyₙ₋ₘ, and dzₙ₋ₘ.

The deviation amount calculating unit 18 outputs the optical axis deviation amounts ΔΦ_{X}, ΔΦ_{Y}, and ΔΦᵣₒₗₗ to the driver monitoring system 3.

When the matching degree C. is less than the threshold Th, the deviation amount calculating unit 18 does not perform each of the calculation processing of the positional deviation amounts dxₙ₋ₘ, dyₙ₋ₘ, and dzₙ₋ₘ and the calculation processing of the optical axis deviation amounts ΔΦ_{X}, ΔΦ_{Y}, and ΔΦᵣₒₗₗ.

In the deviation amount detecting device 2 illustrated in FIG. 20, the deviation amount calculating unit 18 is applied to the deviation amount detecting device 2 illustrated in FIG. 1. However, this is merely an example, and the deviation amount calculating unit 18 may be applied to the deviation amount detecting device 2 illustrated in FIG. 14 or 17.

In FIG. 20, it is assumed that each of the edge image generating unit 11, the pixel searching unit 12, and the deviation amount calculating unit 18, which are components of the deviation amount detecting device 2, is implemented by dedicated hardware as illustrated in FIG. 21. That is, it is assumed that the deviation amount detecting device 2 is implemented by the edge image generating circuit 21, the pixel searching circuit 22, and the deviation amount calculating circuit 28.

Each of the edge image generating circuit 21, the pixel searching circuit 22, and the deviation amount calculating circuit 28 corresponds to, for example, a single circuit, a composite circuit, a programmed processor, a parallel-programmed processor, ASIC, FPGA, or a combination thereof.

The components of the deviation amount detecting device 2 are not limited to those implemented by dedicated hardware, and the deviation amount detecting device 2 may be implemented by software, firmware, or a combination of software and firmware.

In a case where the deviation amount detecting device 2 is implemented by software, firmware, or the like, a program for causing a computer to execute each processing procedure in the edge image generating unit 11, the pixel searching unit 12, and the deviation amount calculating unit 18 is stored in the memory 51 illustrated in FIG. 4. Then, the processor 52 illustrated in FIG. 4 executes the program stored in the memory 51.

In addition, FIG. 21 illustrates an example in which each of the components of the deviation amount detecting device 2 is implemented by dedicated hardware, and FIG. 4 illustrates an example in which the deviation amount detecting device 2 is implemented by software, firmware, or the like. However, this is merely an example, and some components in the deviation amount detecting device 2 may be implemented by dedicated hardware, and the remaining components may be implemented by software, firmware, or the like.

Next, an operation of the deviation amount detecting device 2 illustrated in FIG. 20 will be described.

Since the operation other than the deviation amount calculating unit 18 is similar to that of the deviation amount detecting device 2 illustrated in FIG. 1, only the operation of the deviation amount calculating unit 18 will be described here.

The deviation amount calculating unit 18 acquires each of the reference image G_{REF} and the edge image G_{E} from the pixel searching unit 12.

The deviation amount calculating unit 18 performs pattern matching processing between the contour represented by the reference image G_{REF} and the contour represented by the edge image G_{E}, and specifies a portion where both the contours match and a portion where the contours do not match.

As a matching degree C. between the line shape of the contour represented by the reference image G_{REF} and the line shape of the contour represented by the edge image G_{E}, the deviation amount calculating unit 18 calculates a ratio of portions matching each other in both the contours as expressed in the following Expression (8).

$$C = \{ 1 - ( \frac{K}{M \times 255} ) \} \times 100 [ \% ] \qquad ( 8 )$$

In Expression (8), K is a sum of values of one or more pixels included in a distance image of the portion where both contours match, and M is the total number of pixels of the reference pixel.

When the matching degree C. is equal to or greater than the threshold Th, the deviation amount calculating unit 18 calculates positional deviation amounts dxₙ₋ₘ, dyₙ₋ₘ, and dzₙ₋ₘ from the pixel position (xₘ, yₘ, zₘ) of the imaging pixel P_{E,m} (m=1, . . . , M) output from the pixel searching unit 12 and the pixel position (xₙ, yₙ, zₙ) of the reference pixel P_{REF,n} corresponding to the imaging pixel P_{E,m} output from the pixel searching unit 12, similarly to the deviation amount calculating unit 13 illustrated in FIG. 1. Further, similarly to the deviation amount calculating unit 13 illustrated in FIG. 1, the deviation amount calculating unit 18 calculates optical axis deviation amounts ΔΦ_{X}, ΔΦ_{Y}, and Δ_{φroll} using the positional deviation amounts dxₙ₋ₘ, dyₙ₋ₘ, and dzₙ₋ₘ.

The threshold Th may be stored in the internal memory of the deviation amount calculating unit 18 or may be given from the outside of the deviation amount detecting device 2 illustrated in FIG. 20.

The deviation amount calculating unit 18 outputs the optical axis deviation amounts ΔΦ_{X}, ΔΦ_{Y}, and ΔΦᵣₒₗₗ to the driver monitoring system 3.

When the matching degree C. is less than the threshold Th, calculation accuracy of each of the positional deviation amounts dxₙ₋ₘ, dyₙ₋ₘ, and dzₙ₋ₘ and the optical axis deviation amounts ΔΦ_{X}, ΔΦ_{Y}, and ΔΦᵣₒₗₗ is degraded, and thus, the deviation amount calculating unit 18 does not perform each of the calculation processing of the positional deviation amounts dxₙ₋ₘ, dyₙ₋ₘ, and dzₙ₋ₘ and the calculation processing of the optical axis deviation amounts ΔΦ_{X}, ΔΦ_{Y}, and ΔΦᵣₒₗₗ.

Correction processing of the captured image G_{P}′ using the positional deviation amounts dxₙ₋ₘ, dyₙ₋ₘ, and dzₙ₋ₘ, and the like with low calculation accuracy may conversely increase the degree of blurring of the driver appearing in the captured image G_{P}′. In the driver monitoring system 3 illustrated in FIG. 20, the correction processing of the captured image G_{P}′ using the positional deviation amounts dxₙ₋ₘ, dyₙ₋ₘ, and dzₙ₋ₘ, and the like with low calculation accuracy is not performed, so that it is possible to prevent the increase in the degree of blurring due to the correction processing.

### Fifth Embodiment

In a fifth embodiment, a deviation amount detecting device 2 in which the edge image generating unit 11 performs averaging processing of a plurality of edge images G_{E} will be described.

The configuration of the deviation amount detecting device 2 according to the fifth embodiment is similar to the configuration of the deviation amount detecting device 2 according to any one of the first to fourth embodiments. Therefore, a configuration diagram illustrating the deviation amount detecting device 2 according to the fifth embodiment is FIG. 1, FIG. 14, FIG. 17, or FIG. 20.

The imaging device 1 captures an image of a structure in the vehicle a plurality of times.

The imaging device 1 outputs captured images G_{P}, which are a plurality of images obtained by capturing the structure, to the deviation amount detecting device 2.

The edge image generating unit 11 of the deviation amount detecting device 2 acquires the plurality of captured images G_{P} from the imaging device 1.

The edge image generating unit 11 generates an edge image G_{E} representing the contour of the structure appearing in each captured image G_{P}.

The edge image generating unit 11 performs averaging processing on the plurality of edge images G_{E}, and outputs an edge image G_{Eave} after the averaging processing to the pixel searching unit 12. By performing the averaging processing of the plurality of edge images G_{E}, noise included in the edge images G_{E} is suppressed.

The pixel searching unit 12 searches for a reference pixel P_{REF,n} (n=1, . . . , N) corresponding to the imaging pixel P_{E,m} (m=1, . . . , M) included in the edge image G_{Eave} after the averaging processing, among the N reference pixels P_{REF,1} to P_{REF,N}.

The pixel searching unit 12 outputs the pixel position (xₘ, yₘ, zₘ) of each imaging pixel P_{E,m} (m=1, . . . , M) and the pixel position (xₙ, yₙ, zₙ) of the reference pixel P_{REF,n} corresponding to each imaging pixel P_{E,m} to the deviation amount calculating units 13 and 18.

In the fifth embodiment described above, the deviation amount detecting device 2 is configured so that the distance image generating unit 15 acquires a plurality of images of the inside of the vehicle, generates an edge image representing a contour of a structure appearing in each of the images, and performs averaging processing of a plurality of generated edge images, and the pixel searching unit 12 searches for, among the plurality of reference pixels, a reference pixel corresponding to each of imaging pixels, which are a plurality of pixels indicating a contour represented by the edge image after the averaging processing by the edge image generating unit 11. Therefore, the deviation amount detecting device 2 according to the fifth embodiment can increase detection accuracy of the deviation amount more than the deviation amount detecting device 2 according to the first to fourth embodiments.

In the fifth embodiment, the edge image generating unit 11 outputs the edge image G_{Eave} after the averaging processing to the pixel searching unit 12. However, this is merely an example, and the edge image generating unit 11 may output the edge image G_{Eave} after the averaging processing to the distance image generating unit 15 illustrated in FIG. 17.

In this case, instead of the edge images G_{E}, the distance image generating unit 15 generates the distance image G_{L} from the edge image G_{Eave} after the averaging processing.

Note that, in the present disclosure, free combinations of the embodiments, modifications of any components of the embodiments, or omissions of any components in the embodiments are possible.

### INDUSTRIAL APPLICABILITY

The present disclosure is suitable for a deviation amount detecting device, a deviation amount detecting method, and a driver monitoring system.

### REFERENCE SIGNS LIST

1: imaging device, 2: deviation amount detecting device, 3: driver monitoring system, 11: edge image generating unit, 12: pixel searching unit, 13: deviation amount calculating unit, 14: image correcting unit, 15: distance image generating unit, 16: pixel searching unit, 17: deviation amount calculating unit, 18: deviation amount calculating unit, 21: edge image generating circuit, 22: pixel searching circuit, 23: deviation amount calculating circuit, 24: image correcting circuit, 25: distance image generating circuit, 26: pixel searching circuit, 27: deviation amount calculating circuit, 28: deviation amount calculating circuit, 31: sensing unit, 32: warning output unit, 33: sensing unit, 41: sensing circuit, 42: warning output circuit, 43: sensing circuit, 51: memory, 52: processor

1. A deviation amount detecting device comprising:
processing circuitry configured to
acquire an image of an inside of a vehicle captured by an imaging device, and generate an edge image representing a contour of a structure appearing in the image;
acquire a reference image representing the contour of the structure when an installation position of the imaging device is a correct installation position, search for a reference pixel corresponding to each of imaging pixels, which are a plurality of pixels indicating the contour represented by the generated edge image, from among reference pixels, which are a plurality of pixels indicating the contour represented by the reference image, and output a pixel position of each of the imaging pixels and a pixel position of the reference pixel corresponding to each of the imaging pixels;
calculate a positional deviation amount, which is a deviation amount between the installation position of the imaging device and the correct installation position, from the pixel position of each of the imaging pixels having been output and the pixel position of the reference pixel corresponding to each of the imaging pixels having been output;
calculate, using the positional deviation amount, an optical axis deviation amount that is a deviation amount between an optical axis of the imaging device and an optical axis of the imaging device when an installation angle of the imaging device is a correct installation angle; and
correct the image of the inside of the vehicle captured by the imaging device by using the optical axis deviation amount.

2-3. (canceled)

4. A deviation amount detecting device comprising:
processing circuitry configured to
acquire an image of an inside of a vehicle captured by an imaging device, and generate an edge image representing a contour of a structure appearing in the image;
acquire a reference image representing the contour of the structure when an installation position of the imaging device is a correct installation position, search for a reference pixel corresponding to each of imaging pixels, which are a plurality of pixels indicating the contour represented by the generated edge image, from among reference pixels, which are a plurality of pixels indicating the contour represented by the reference image, and output a pixel position of each of the imaging pixels and a pixel position of the reference pixel corresponding to each of the imaging pixels;
calculate a positional deviation amount, which is a deviation amount between the installation position of the imaging device and the correct installation position, from the pixel position of each of the imaging pixels having been output and the pixel position of the reference pixel corresponding to each of the imaging pixels having been output;
generate, from the generated edge image, a distance image in which a pixel at a position farther from the contour represented by the edge image has a larger luminance value; and
search for, instead of searching for a reference pixel corresponding to each of imaging pixels among the plurality of reference pixels, a reference pixel corresponding to each of distance pixels, which are a plurality of pixels indicating a contour represented by the generated distance image, among the plurality of reference pixels, and output a pixel position of each of the distance pixels and a pixel position of the reference pixel corresponding to each of the distance pixels, and
calculate the positional deviation amount from the pixel position of each of the distance pixels having been output and the pixel position of the reference pixel corresponding to each of the distance pixels having been output.

5. A deviation amount detecting device comprising:
processing circuitry configured to
acquire an image of an inside of a vehicle captured by an imaging device, and generate an edge image representing a contour of a structure appearing in the image;
acquire a reference image representing the contour of the structure when an installation position of the imaging device is a correct installation position, search for a reference pixel corresponding to each of imaging pixels, which are a plurality of pixels indicating the contour represented by the generated edge image, from among reference pixels, which are a plurality of pixels indicating the contour represented by the reference image, and output a pixel position of each of the imaging pixels and a pixel position of the reference pixel corresponding to each of the imaging pixels;
calculate a positional deviation amount, which is a deviation amount between the installation position of the imaging device and the correct installation position, from the pixel position of each of the imaging pixels having been output and the pixel position of the reference pixel corresponding to each of the imaging pixels having been output; and
calculate the positional deviation amount from the pixel position of each of the imaging pixels and the pixel position of the reference pixel corresponding to each of the imaging pixels only when a matching degree between a line shape of the contour represented by the reference image and a line shape of the contour represented by the edge image is equal to or greater than a threshold.

6. A deviation amount detecting device comprising:
processing circuitry configured to
acquire an image of an inside of a vehicle captured by an imaging device, and generate an edge image representing a contour of a structure appearing in the image;
acquire a reference image representing the contour of the structure when an installation position of the imaging device is a correct installation position, search for a reference pixel corresponding to each of imaging pixels, which are a plurality of pixels indicating the contour represented by the generated edge image, from among reference pixels, which are a plurality of pixels indicating the contour represented by the reference image, and output a pixel position of each of the imaging pixels and a pixel position of the reference pixel corresponding to each of the imaging pixels; and
calculate a positional deviation amount, which is a deviation amount between the installation position of the imaging device and the correct installation position, from the pixel position of each of the imaging pixels having been output and the pixel position of the reference pixel corresponding to each of the imaging pixels having been output;
acquires a plurality of images of the inside of the vehicle, generates the edge image representing the contour of the structure appearing in each of the images, and performs averaging processing of a plurality of generated edge images; and
search for, among the plurality of reference pixels, a reference pixel corresponding to each of imaging pixels, which are a plurality of pixels indicating a contour represented by the edge image after the averaging processing.

7. The deviation amount detecting device according to claim 1, wherein the structure appearing in the image of the inside of the vehicle is a window frame, an assist grip, a headrest, a B-pillar, a door frame, a shoulder anchor, or a sun visor of the vehicle.

8. The deviation amount detecting device according to claim 1, wherein
the structure appearing in the image of the inside of the vehicle is a part of a window frame of the vehicle, and
the part of the window frame includes an upper side portion of the window frame and a side portion of the window frame in contact with the upper side portion of the window frame, or includes only the upper side portion of the window frame.

9. The deviation amount detecting device according to claim 1, wherein the imaging device is installed on a center console, a steering wheel column, an A-pillar, a rearview mirror, a dashboard, an instrument panel, or a ceiling.

10.-11. (canceled)

12. The deviation amount detecting device according to claim 2, wherein the processing circuitry is configured to calculate, using the positional deviation amount, an optical axis deviation amount that is a deviation amount between an optical axis of the imaging device and an optical axis of the imaging device when an installation angle of the imaging device is a correct installation angle.

13. A driver monitoring system comprising a sensor to monitor a state of an occupant of the vehicle using an optical axis deviation amount calculated by the processing circuitry of the deviation amount detecting device according to claim 12 and an image of the inside of the vehicle captured by an imaging device.

14. A deviation amount detecting method comprising:
acquiring an image of an inside of a vehicle captured by an imaging device, and generating an edge image representing a contour of a structure appearing in the image;
acquiring a reference image representing the contour of the structure when an installation position of the imaging device is a correct installation position, searching for a reference pixel corresponding to each of imaging pixels, which are a plurality of pixels indicating the contour represented by the generated edge image, from among reference pixels, which are a plurality of pixels indicating the contour represented by the reference image, and outputting a pixel position of each of the imaging pixels and a pixel position of the reference pixel corresponding to each of the imaging pixels; and
calculating a positional deviation amount, which is a deviation amount between the installation position of the imaging device and the correct installation position, from the pixel position of each of the imaging pixels having been output and the pixel position of the reference pixel corresponding to each of the imaging pixels having been output;
generating, from the generated edge image, a distance image in which a pixel at a position farther from the contour represented by the edge image has a larger luminance value;
searching for, instead of searching for a reference pixel corresponding to each of imaging pixels among the plurality of reference pixels, a reference pixel corresponding to each of distance pixels, which are a plurality of pixels indicating a contour represented by the generated distance image, among the plurality of reference pixels;
outputting a pixel position of each of the distance pixels and a pixel position of the reference pixel corresponding to each of the distance pixels; and
calculating the positional deviation amount from the pixel position of each of the distance pixels having been output and the pixel position of the reference pixel corresponding to each of the distance pixels having been output.
